(19) United States
(12) Patent Application Publication
(10) Pub. No.: US 2014/0270998 A1
(43) Pub. Date: Sep. 18, 2014

(54) PNEUMATIC CONVEYOR FABRIC FRAMES AND MOUNTS

(71) Applicant: BABCOCK POWER SERVICES, INC., Worcester, MA (US)

(72) Inventors: Michael Johnson, Auburn, MA (US); Brian Ledoux, Charlton, MA (US); Robert L. Brockway, Rutland, MA (US)

(73) Assignee: BABCOCK POWER SERVICES, INC., Worcester, MA (US)

(21) Appl. No.: 13/826,062

(22) Filed: Mar. 14, 2013

(51) Int. Cl. B65G 53/20

(52) U.S. Cl. CPC B65G 53/20
USPC 406/194

(57) ABSTRACT

A fixed length fabric frame includes a perforated plate configured and adapted to support the weight of a solid particle material being transported. It also has a fabric sheet mounted to the perforated plate. The fabric sheet is configured and adapted to evenly distribute pressurized air within the conveyor. A backing flange is mounted to the fabric sheet. The backing flange is configured and adapted to contain the fabric sheet. Fixed length fabric frames can be used in a particle conveyance system to separate a pressurized plenum from a conveyance volume. Traditional particle conveyance systems can be retrofitted to utilize fixed length fabric frames.

### BACKGROUND OF THE INVENTION

1. Field of the Invention

The present invention relates to solid particle conveyors, such as pneumatic conveyors, and more particularly to fabric frames and mounts for use in the conveyors.

2. Description of Related Art

Pneumatic conveyor systems allow for solid materials to be transferred through a plenum from one point to another without the need for a traditional belt conveyor system. Pneumatic conveyor systems use a pressurized airflow through the material to fluidize the material and allow for gravity to move the material through the conveyor system at angles of inclination significantly less than the angle of repose for the material. Traditionally pneumatic conveyor systems use a continuous length of pneumatized fabric to support and transport the material within the conveyor.

Such conventional methods and systems have generally been considered satisfactory for their intended purpose. However, there is still a need in the art for a systems and methods that allow for easier and more efficient installation and removal of components in pneumatic conveyors. There also remains a need in the art for such systems and methods that are easy to make and use. The present invention provides a solution for these problems.

### SUMMARY OF THE INVENTION

The subject invention is directed to a new and useful fixed length fabric frame for a solid particle conveyor. The fixed length fabric frame includes a perforated plate configured and adapted to support the weight of a solid particle material being transported. A fabric sheet is mounted to the perforated plate. The fabric sheet is configured and adapted to evenly distribute pressurized air within a conveyor. A backing flange is mounted to the fabric sheet. The backing flange is configured and adapted to contain the fabric sheet.

In certain embodiments, the backing flange can be defined along the perimeter of the perforated plate and fabric sheet, with the fabric sheet mounted in tension. The perforated plate, fabric sheet and backing flange all can be generally rectangular. The fabric sheet can be mounted between the perforated plate and the backing flange.

The invention also provides a solid particle conveyance system. The system includes a conveyor defining an interior space, a mounting rail within the interior space of the conveyor, and a fixed length fabric frame as described above. The fixed length fabric frame is disposed within the interior space of the conveyor proximate the mounting rail to divide the interior space into a plenum of pressurized air and a conveyance volume.

In accordance with certain embodiments, the conveyor is a single continuous conveyor, continuous from an inlet thereof to an outlet thereof. The mounting rail can include fixed mounting points mounted to corresponding points on the fixed length fabric frame. The mounting rail and the fixed length fabric frame can each have a generally rectangular perimeter. The solid particle conveyance system can include a plurality of mounting rails and corresponding fixed length fabric frames that are mounted in the conveyor end to end lengthwise. The plurality of mounting rails and fabric frames can be configured and adapted to divide the plenum of pressurized air into individually pressurized and controlled plena.

The invention also provides a method for retrofitting a solid particle conveyance system. The method includes adding a mounting rail to a single continuous conveyor defining an interior space. The conveyor is continuous from an inlet thereof to an outlet thereof, and the mounting rail is configured and adapted to mount a fabric frame within the interior space of the conveyor to divide the interior space into a plenum of pressurized air and a conveyance volume.

In certain embodiments, the method includes inserting a fixed length fabric frame, as described above, into the conveyor. Inserting the fixed length fabric frame can include mounting the fixed length fabric frame to the mounting rail. It is also contemplated that mounting the fixed length fabric frame to the mounting rail can include mounting the fixed length fabric frame to the mounting rail at the fixed mounting points described above.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a cut away perspective view of an exemplary embodiment of a solid particle conveyance system constructed in accordance with the present invention, showing the conveyor with fixed length fabric frames mounted to the mounting rails;

FIG. 2 is an enlarged partially cross-sectional perspective view of a portion of the system of FIG. 1, showing an end to end connection of two of the fixed length fabric frames;

FIG. 3 is a cut away exploded view of the system of FIG. 1, showing one of the fixed length fabric frames removed from the mounting rails; and

FIG. 4 is an exploded perspective view of a portion of the fixed length fabric frame of FIG. 3, showing how the fabric sheet is mounted between the perforated plate and the backing flange.

### DETAILED DESCRIPTION OF THE PREFERRED EMBODIMENTS

Reference will now be made to the drawings wherein like reference numerals identify similar structural features or aspects of the subject invention. For purposes of explanation and illustration, and not limitation, a partial view of an exemplary embodiment of the solid particle conveyance system in accordance with the invention is shown in FIG. 1 and is designated generally by reference character 100. Other embodiments of solid particle conveyance systems in accordance with the invention, or aspects thereof, are provided in FIGS. 2-4, as will be described.

Referring now to FIG. 1, solid particle conveyance system 100 includes a conveyor 102 defining a plenum 104 that can be pressurized, for example with air or any other suitable gas. A mounting rail 106 is included within conveyor 102. A plurality of fixed length fabric frames 108 are mounted to rails 106 to divide the interior space of conveyor 102 into a plenum 104 of pressurized air and a conveyance volume 110.

Referring now to FIG. 2, conveyor is 102 a single continuous conveyor, continuous from an inlet thereof, e.g., towards the upper end as oriented in FIG. 1 to an outlet thereof, e.g., toward the lower end as oriented in FIG. 1. The plurality of mounting rails 106 and corresponding fixed length fabric frames 108 are mounted in conveyor 102 end to end lengthwise so plenum 104 is a single pressurized space. Optionally, division plates can be included at the joints between rails 106, as indicated by dashed lines in FIG. 2, to divide plenum 104 into two or more individually controllable pressurized plena. This can be beneficial, for example if the pressure along conveyor 102 needs to be changed along its length, and/or to make it easier to locate pressure leaks. While four fixed length fabric frames 108 are depicted in FIG. 1, those skilled in the art will readily appreciate that any suitable number can be used without departing from the scope of this disclosure.

With reference now to FIG. 3, mounting rails 106 include fixed mounting points 112, which when assembled are mounted with fasteners 124 to corresponding points 114 on fixed length fabric frame 108. Mounting rails 106 and fixed length fabric frames 108 each have a generally rectangular perimeter fitted for end to end assembly as described above.

Referring now to FIG. 4, fixed length fabric frames 108 each include a perforated plate 116 configured and adapted to support the weight of a solid particle material being transported. A fabric sheet 118 is mounted to perforated plate 116. Fabric sheet 118 is configured and adapted to evenly distribute pressurized air within conveyor 102. The evenly distributed air flows from plenum 104 through perforated plate 116 and fabric sheet 118 to fluidize solid particle material in conveyance volume 110 for transport through conveyor 102. A backing flange 120 is mounted to fabric sheet 118 to contain fabric sheet 118 between backing flange 120 and perforated plate 116. Fasteners 122 or any other suitable joining means can be used to join backing flange 120, fabric sheet 118, and perforated plate 116, as indicated by the assembly lines in FIG. 4, so that fabric sheet 118 is stretched tight and mounted in tension, which provides for proper air flow. Perforated plate 116, fabric sheet 118, and backing flange 120 are all rectangular, and backing flange 120 is defined along the perimeter of perforated plate 116 and fabric sheet 118.

The systems and method described above can facilitate installation and removal of pneumatic conveyor components compared to traditional systems which rely on single continuous lengths pneumatized fabric running the length of the plenum. In those traditional systems, the entire plenum must be disassembled to remove the fabric, and great care must be taken along its entire length to ensure proper installation. The fixed length fabric frames in accordance with this disclosure are easier to handle during installation and removal due to their limited size and the pre-stretched state of the fabric in the frame formed by the perforated plate and backing flange. Moreover, if a single one of the fixed length fabric frame becomes worn or damaged, it may not be necessary to replace all of the fabric in the conveyor since the single frame can be removed and replaced on its own. In addition to facilitating repairs and modifications, the fixed size of the fabric frames described herein can also assist in keeping a stock of spare parts and materials. All of these benefits can ultimately reduce down time when maintenance occurs. Additionally, since the mounting rails described above are mounted internally within a continuous length of conveyor, there are no joints in the conveyor shell where pressure leaks can occur.

A traditional conveyor can be retrofitted to utilize fixed length fabric frames as those described above and to form a solid particle conveyance system in accordance with the subject invention. The retrofit includes adding a mounting rail, e.g., mounting rail 106, to a single continuous conveyor defining a plenum, e.g., conveyor 102. A fixed length fabric frame, e.g., fixed length fabric frame 108, can then be inserted into the conveyor and mounted to the mounting rail at the fixed mounting points, e.g., fixed mounting points 112.

The methods and systems of the present invention, as described above and shown in the drawings, provide for solid particle conveyance with superior properties including facilitated installation and removal of components. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A fixed length fabric frame for a solid particle conveyor comprising:
a perforated plate configured and adapted to support the weight of a solid particle material being transported;
a fabric sheet mounted to the perforated plate, the fabric sheet configured and adapted to evenly distribute pressurized air within a conveyor; and
a backing flange mounted to the fabric sheet, wherein the backing flange is configured and adapted to contain the fabric sheet.

2. A fixed length fabric frame as recited in claim 1, wherein the backing flange is mounted along a perimeter defined by the perforated plate and fabric sheet.

3. A fixed length fabric frame as recited in claim 1, wherein the perforated plate, fabric sheet and backing flange are all generally rectangular.

4. A fixed length fabric frame as recited in claim 1, wherein the fabric sheet is mounted between the perforated plate and the backing flange.

5. A fixed length fabric frame as recited in claim 1, wherein the fabric sheet is mounted in tension.

6. A solid particle conveyance system comprising:
a conveyor defining an interior space;
a mounting rail within the interior space of the conveyor; and
the fixed length fabric frame as recited in claim 1, wherein the fixed length fabric frame is disposed within the interior space of the conveyor proximate the mounting rail to divide the interior space of the conveyor into a plenum of pressurized air and a conveyance volume.

7. A solid particle conveyance system as recited in claim 6, wherein conveyor is a single continuous conveyor, continuous from an inlet thereof to an outlet thereof.

8. A solid particle conveyance system as recited in claim 6, wherein the mounting rail includes fixed mounting points mounted to corresponding points on the fixed length fabric frame.

9. A solid particle conveyance system as recited in claim 6, wherein the mounting rail and the fixed length fabric frame each have a generally rectangular perimeter.

10. A solid particle conveyance system as recited in claim 6, wherein a plurality of mounting rails and corresponding fixed length fabric frames are mounted in the conveyor end to end lengthwise.

11. A solid particle conveyance system as recited in claim 10, wherein the plurality of mounting rails and fabric frames are configured and adapted to divide the plenum of pressurized air into individually pressurized and controlled plena.

12. A solid particle conveyance system as recited in claim 6, wherein the backing flange of the fixed length fabric frame is mounted along a perimeter defined by the perforated plate and fabric sheet.

13. A solid particle conveyance system as recited in claim 6, wherein the perforated plate, fabric sheet and backing flange of the fixed length fabric frame are all generally rectangular.

14. A solid particle conveyance system as recited in claim 6, wherein the fabric sheet is mounted between the perforated plate and backing flange.

15. A solid particle conveyance system as recited in claim 6, wherein the fabric sheet is mounted in tension between the perforated plate and backing flange.

16. A method for retrofitting a solid particle conveyance system, comprising:
adding a mounting rail to a single continuous conveyor defining an interior space, wherein the conveyor is continuous from an inlet thereof to an outlet thereof, and wherein the mounting rail is configured and adapted to mount a fabric frame within the interior space of the conveyor to divide the interior space into a plenum of pressurized air and a conveyance volume.

17. A method for retrofitting a solid particle conveyance system as recited in claim 16, further comprising inserting a fixed length fabric frame of claim 1 into the conveyor, wherein inserting the fixed length fabric frame includes mounting the fixed length fabric frame to the mounting rail.

18. A method for retrofitting a solid particle conveyance system as recited in claim 17, further comprising mounting the fabric sheet in tension.

19. A method for retrofitting a solid particle conveyance system as recited in claim 17, wherein the mounting rail includes fixed mounting points corresponding to respective points on the fixed length fabric frame.

20. A method for retrofitting a solid particle conveyance system as recited in claim 19, wherein mounting the fixed length fabric frame to the mounting rail includes mounting the fixed length fabric frame to the mounting rail at the fixed mounting points.
